(19) United States
(12) Patent Application Publication
(10) Pub. No.: US 2022/0264961 A1
(43) Pub. Date: Aug. 25, 2022

(54) MOLDED ARTICLES MADE WITH CELLULOSE ESTER FIBERS

(71) Applicant: Eastman Chemical Company, Kingsport, TN (US)

(72) Inventor: Rohit Pravin Kankaliya, Kingsport, TN (US)

(73) Assignee: Eastman Chemical Company, Kingsport, TN (US)

(21) Appl. No.: 17/597,094

(22) PCT Filed: May 27, 2020
(86) PCT No.: PCT/US2020/034638

§ 371 Date: Dec. 27, 2021

Related U.S. Application Data
(60) Provisional application No. 62/868,428, filed on Jun. 28, 2019.

(51) Int. Cl. A41C 3/00; B29C 70/16

(52) U.S. Cl. CPC A41C 3/0014; B29C 70/16; B29K 2201/08

(57) ABSTRACT

Thermoformed molded articles are made containing and from fabrics containing spandex and cellulose ester fibers. In the process for making the molded article, a fabric is layed up in a mold a thermoformed at a temperature not exceeding 195° C., and for a residence time sufficient to obtain a molded article that retains its shape upon release from the mold, said fabric comprising cellulose ester fibers. The three-dimensional molded articles can now be made containing sustainably derived fibers, e.g. cellulose ester fibers, that have good shape retention, comfort, and hand. Examples of such molded articles include support garments, such a brassiers.

### FIELD OF THE INVENTION

The invention related to molded articles and fabrics useful to make such molded articles, in which each contains cellulose ester fibers.

### BACKGROUND OF THE INVENTION

Thermoplastic synthetic fibers such as polyester and nylon are commonly used in a variety of molded applications, including supporting garments such as brassieres, sports bras or bralettes. Due to the thermoplastic nature of these fibers, fabrics made from these fibers with appropriate fabric attributes can be molded into different size and styles for molded articles.

We desire to employ a sustainably sourced material as a fiber for use in molded articles. Cellulosic materials such as cotton have been and are used in the molded applications in limited proportion and in combination with other thermoplastic synthetic fibers. Its use is limited since cotton is not a thermoplastic, and is used in combination with cross-linking agents and other chemical additives to enable fabrics containing cotton to retain their shape upon molding. These and other challenges have limited the use of cotton in molding applications. Similar problems are encountered with regenerated cellulosic materials such as viscose and rayons since they do not exhibit any or poor thermoplastic behavior. Thus, there remains a need to provide a sustainably sourced fiber that exhibits good thermoplastic behavior to make a molded product that, upon molding, has good shape retention.

Further, the molding conditions employed for such a fiber should be within a range that continues to allow other conventional thermoplastic synthetic fibers such as nylons and polyesters to continue to exceed their Tg yet not reach their melting point while simultaneously softening the sustainably sourced fiber to provide a good weld with the conventional fibers and retain the shape of the molded article after cooling.

It is also desirable to employ a fiber that, when blended with other fibers, does not deteriorate, and can even enhance, the comfort of the textile to the wearer and which also has a good hand feel. These features are particularly important when the molded article is one which contacts a wearer's skin.

### SUMMARY OF THE INVENTION

There is now provided a thermoformed molded article comprising spandex and cellulose ester fibers.

There is also provided a process for making a molded article comprising molding a fabric in a mold at a mold set point, or at a maximum fabric temperature, not exceeding 195° C., and for a residence time sufficient to obtain a molded article that retains its shape upon release from the mold, said fabric comprising cellulose ester fibers.

The three-dimensional molded articles can now be made containing sustainably derived fibers, e.g. cellulose ester fibers, that have good shape retention, comfort, and hand.

### DETAILED DESCRIPTION OF THE INVENTION

We have discovered that a sustainably sourced fibers of cellulose esters (CE) having a low denier per filament and low total denier can be successfully molded with other thermoplastic and natural fibers into 3 dimensional objects having good shape retention, comfort and hand feel.

As used herein, reference to weight percentage based on the weight of the molded article excludes the weight of all materials used to make the molded article except the fabric containing the CE fibers that is molded. A fabric refers to a knitted, woven or nonwoven material. A three-dimensional article is non-planar as a whole and distinguishable from a sheet, paper, fabric, or film which are planar.

The CE fibers have a denier per filament of less than 5, or not more than 4, or not more than 3, or not more than 2.8, or not more than 2.5, or not more than 2.3, or not more than 2, or not more than 1.9, or not more than 1.8, or not more than 1.7, or not more than 1.5, or not more than 1.3, and in addition or in the alternative, the dpf can be at least 0.8, or at least 0.9, or at least 1, or at least 1.1, or at least 1.3, or at least 1.5, or at least 1.7. Suitable ranges include 0.8-5, or 0.9-5, or 1-5, or 1.3-5, or 1.5-5, or 1.7-5, or 0.8-4, or 0.9-4, or 1-4, or 1.3-4, or 1.5-4, or 1.7-4, or 0.8-3, or 0.9-3, or 1-3, or 1.3-3, or 1.5-3, or 1.7-3, or 0.8-2.8, or 0.9-2.8, or 1-2.8, or 1.3-2.8, or 1.5-2.8, or 1.7-2.8, or 0.8-2.5, or 0.9-2.5, or 1-2.5, or 1.3-2.5, or 1.5-2.5, or 0.8-2.3, or 0.9-2.3, or 1-2.3, or 1.3-2.3, or 1.5-2.3, or 1.7-2.3, or 0.8-2, or 0.9-2, or 1-2, or 1.3-2, or 1.5-2, or 1.7-1.8, or 0.8-1.8, or 0.9-1.8, or 1-1.8, or 1.3-1.8, or 1.5-1.8, or 1.7-1.8. CE fibers employed in the molded articles having a dpf of higher than 5 can impart an undesirably crispy feel to the fabric unless softening agents are applied or greater quantities of softening agents are applied. CE fibers having a low dpf have a higher comfort and hand feel to the wearer.

The total denier of the CE fibers is desirably not more than 250, or not more than 225, or not more than 200, or not more than 185, or not more than 165, or not more than 150, or not more than 140, or not more than 130, or not more than 110, or not more than 100, or not more than 90, or not more than 85, or not more than 80, or not more than 75, and in addition or in the alternative, at least 25, or at least 30, or at least 35, or at least 40, or at least 45, or at least 50, or at least 55, or at least 60, or at least 65. Suitable ranges include 25-250, or 30-250, or 35-250, or 40-250, or 45-250, or 50-250, or 55-250, or 60-250, or 65-250, or 25-185, or 30-185, or 35-185, or 40-185, or 45-185, or 50-185, or 55-185, or 60-185, or 65-185, or 25-165, or 30-165, or 35-165, or 40-165, or 45-165, or 50-165, or 55-165, or 60-165, or 65-165, or 25-150, or 30-150, or 35-150, or 40-150, or 45-150, or 50-150, or 55-150, or 60-150, or 65-150, or 25-140, or 30-140, or 35-140, or 40-140, or 45-140, or 50-140, or 55-140, or 60-140, or 65-140, or 25-130, or 30-130, or 35-130, or 40-130, or 45-130, or 50-130, or 55-130, or 60-130, or 65-130, or 25-110, or 30-110, or 35-110, or 40-110, or 45-110, or 50-110, or 55-110, or 60-110, or 65-110, or 25-100, or 30-100, or 35-100, or 40-100, or 45-100, or 50-100, or 55-100, or 60-100, or 65-100, or 25-90, or 30-90, or 35-90, or 40-90, or 45-90, or 50-90, or 55-90, or 60-90, or 65-90, or 25-85, or 30-85, or 35-85, or 40-85, or 45-85, or 50-85, or 55-85, or 60-85, or 65-85, or 25-80, or 30-80, or 35-80, or 40-80, or 45-80, or 50-80, or 55-80, or 60-80, or 65-80. Fabrics made with the CE fibers having a total denier of over 250 have a high weight that for many applications impairs the comfort to the wearer. For many applications, especially for braziers and sport fabrics, the wearer desires a lighter weight fabric.

The CE fibers contain filaments and have a filament count per fiber. Desirably, the filament count per fiber is less than 300, or not more than 250, or not more than 225, or not more than 200, or not more than 180, or not more than 160, or not more than 150, or not more than 125, or not more than 100, or not more than 85, or not more than 75, or not more than 60, or not more than 55, or not more than 50, and in addition or in the alternative, at least 10, or at least 15, or at least 20, or at least 25, or at least 30, or at least 35, or at least 40.

The CE fibers are continuous fibers. The continuous fibers have an average length of at least 125 mm, or at least 140 mm, or at least 150 mm, or at least 170 mm, or at least 180 mm, or at least 200 mm, or at least 225 mm, or at least 250 mm, or at least 300 mm, or at least 400 mm, or at least 500 mm, or at least 600 mm, or at least 700 mm.

The CE fibers include cellulose derivatized with a reactive compound to generate at least one ester linkage at the hydroxyl site on the cellulose backbone, such as cellulose acetate, cellulose diacetate, cellulose triacetate, cellulose propionate, cellulose butyrate, cellulose acetate formate, cellulose acetate propionate, cellulose acetate butyrate, cellulose propionate butyrate, and mixtures thereof. Although described herein with reference to “cellulose acetate,” it should be understood that one or more of the above cellulose acid esters or mixed esters may also be used to form the fibers. Various types of cellulose esters are described, for example, in U.S. Pat. Nos. 1,698,049; 1,683,347; 1,880,808; 1,880,560; 1,984,147, 2,129,052; and 3,617,201, each of which is incorporated herein by reference to the extent not inconsistent with the present disclosure. As used herein, regenerated cellulose (e.g., viscose, rayon, or lyocell) and the fibers made therefrom are not classified as CE polymers or CE fibers.

In one embodiment or in any of the mentioned embodiments, the CE fibers are virgin CE fibers. In one embodiment or in any of the mentioned embodiments, the CE fibers are desirably not processed through a refiner, or are not refined, or are non-fibrillated, prior to or upon combining them with other fibers.

The cellulose ester polymer used to make the fibers can have a degree of substitution that is not limited, although a degree of substitution in the range of from 1.8 to 2.9 is desirable. As used herein, the term “degree of substitution” or “DS” refers to the average number of acyl substituents per anhydroglucose ring of the cellulose polymer, wherein the maximum degree of substitution is 3.0. In some cases, the cellulose ester used to form fibers as described herein may have a degree of substitution of at least 1.8, or at least 1.90, or at least 1.95, or at least 2.0, or at least 2.05, or at least 2.1, or at least 2.15, or at least 2.2, or at least 2.25, or at least 2.3 and/or not more than about 2.9, or not more than 2.85, or not more than 2.8, or not more than 2.75, or not more than 2.7, or not more than 2.65, or not more than 2.6, or not more than 2.55, or not more than 2.5, or not more than 2.45, or not more than 2.4, or not more than 2.35. Desirably, at least 90, or at least 91, or at least 92, or at least 93, or at least 94, or at least 95, or at least 96, or at least 97, or at least 98, or at least 99 percent of the cellulose ester has a degree of substitution of at least 2.15, or at least 2.2, or at least 2.25. Typically, acetyl groups can make up at least about 1, 5, 10, 15, 20, 25, 30, 35, 40, 45, 50, 55, or 60 percent and/or not up to 100% or not more than about 99, or not more than 95, or not more than 90, or not more than 85, or not more than 80, or not more than 75, or not more than 70 percent of the total acyl substituents. Desirably, greater than 90 weight percent, or greater than 95%, or greater than 98%, or greater than 99%, and up to 100 wt. % of the total acyl substituents are acetyl substituents (C2). The cellulose ester can have no acyl substituents having a carbon number of greater than 2.

In an embodiment or in any of the mentioned embodiments, the DS of the cellulose ester polymer is not more than 2.5, or not more than 2.45. Both the industrial and home compostability of CE fibers is most effective when made with cellulose esters having a DS of not more than 2.5. Additionally, those CE fibers made with cellulose ester polymers having a DS of not more than 2.5 are also soil biodegradable under the ISO 17566 test method.

The cellulose ester may have a weight-average molecular weight (Mw) of not more than 90,000, measured using gel permeation chromatography with N-methyl-2-pyrrolidone (NMP) as the solvent. In some case, the cellulose ester may have a molecular weight of at least about 10,000, at least about 20,000, 25,000, 30,000, 35,000, 40,000, or 45,000 and/or not more than about 100,000, 95,000, 90,000, 85,000, 80,000, 75,000, 70,000, 65,000, 60,000, or 50,000.

Desirably, the CE fibers are mono-component fibers, meaning that there are no discrete phases, such as islands, domains, or sheaths of alternate polymers in the fiber other than the CE polymer. For example, a mono-component fiber can be entirely made of CE polymer, or a melt blend of a CE polymer and a different polymer. Desirably, at least 60% of the CE fibers are CE polymers, or at least 70%, or at least 75%, or at least 80%, or at least 90%, or at least 92%, or at least 95%, or at least 98%, or at least 99%, or 100% by weight of the CE fibers are CE polymers, based on the weight of all polymers in the fiber having a number average molecular weight of over 500 (or alternatively based on the weight of all polymers used to spin filaments from which the CE fibers are made). For clarity, these percentages do not exclude spin or cutting finishes applied to the filaments once spun or other additives which have a number average molecular weight of less than 500.

The cellulose ester may be formed by any suitable method, and desirably the CE fibers are obtained from filaments formed by the wet spinning or also known as the solvent spun method, which is a method distinct from a precipitation method or emulsion flashing or melt spinning. In a solvent spun method, the cellulose ester flake is dissolved in a solvent, such as acetone or methyl ethyl ketone, to form a “solvent dope,” which can be filtered and sent through a spinnerette to form continuous cellulose ester filaments. In some cases, up to about 3 wt. % or up to 2 wt. %, or up to 1 weight percent, or up to 0.5 wt. %, or up to 0.25 wt. %, or up to 0.1 wt. % based on the weight of the dope, of titanium dioxide or other delusterant may be added to the dope prior to filtration, depending on the desired properties and ultimate end use of the fibers, or alternatively, no titanium dioxide is added. The continuous cellulose ester filaments are then cut to the desired length leading to CE fibers having low cut length variability, and consistent L/D ratios, and the ability to supply them as dry fibers. By contrast, cellulose ester forms made by the precipitation method have low length consistency, have a random shape, a wide DPF distribution, have a wide L/D distribution, cannot be crimped, and are supplied wet.

In some cases, the solvent dope or flake used to form the CE fibers may include few or no additives in addition to the cellulose ester. Such additives can include, but are not limited to, plasticizers, antioxidants, thermal stabilizers, pro-oxidants, acid scavengers, inorganics, pigments, and colorants. In some cases, the CE fibers as described herein can include at least about 90, or at least 90.5, or at least 91, or at least 91.5, or at least 92, or at least 92.5, or at least 93, or at least 93.5, or at least 94, or at least 94.5, or at least 95, or at least 95.5, or at least 96, or at least 96.5, or at least 97, or at least 97.5, or at least 98, or at least 98.5, or at least 99, or at least 99.5, or at least 99.9, or at least 99.99, or at least 99.995, or at least 99.999 percent cellulose ester, based on the total weight of the fiber. The fibers may include or contain not more than 10, or not more than 9.5, or not more than 9, or not more than 8.5, or not more than 8, or not more than 7.5, or not more than 7, or not more than 6.5, or not more than 6, or not more than 5.5, or not more than 5, or not more than 4.5, or not more than 4, or not more than 3.5, or not more than 3, or not more than 2.5, or not more than 2, or not more than 1.5, or not more than 1, or not more than 0.5, or not more than 0.1, or not more than 0.01, or not more than 0.005, or not more than 0.001 weight percent of plasticizers, or optionally all additives, in the cellulose ester polymer or deposited onto the cellulose ester fiber or contained on or in the CE fiber, including but not limited to the specific additives listed herein.

At the spinnerette, the solvent dope can be extruded through a plurality of holes to form continuous cellulose ester filaments. At the spinnerette, filaments may be drawn to form bundles. The spinnerette may be operated at any speed suitable to produce filaments, which are then assembled into bundles having desired size and shape. Multiple bundles may be assembled into a filament band such as, for example, a crimped or uncrimped tow band. The filament band may be of any suitable size and have a total denier as mentioned above.

The individual filaments which are spun in a generally longitudinally aligned manner and which ultimately form the tow band, are of a particular size. The linear denier per filament (weight in g of 9000 m fiber length), or DPF, of the CE filaments and of the corresponding CE fibers, are desirably within a range as described above. The particular method for measurement is not limited, and include ASTM 1577-07 using the FAVIMAT vibroscope procedure if filaments can be obtained from which the staple fibers are cut, or a width analysis using any convenient optical microscopy or Metso.

In another embodiment or in any one of the mentioned embodiments, the maximum width of the fibers are not more than 50 microns, or not more than 45 microns, or not more than 40 microns, or not more than 36 microns, or not more than 34 microns, or not more than 32 microns, or not more than 30 microns, or not more than 28 microns, or not more than 27 microns, or not more than 26 microns, or not more than 25 microns, or not more than 24.5 microns, or not more than 24 microns, or not more than 22 microns, or not more than 20 microns.

In one embodiment or in any of the mentioned embodiments, at least 70%, or at least 80%, or at least 85%, or at least 90%, or at least 95%, or at least 97% of the CE fibers have a DPF within +/−20% of any one of the above stated DPF. Alternatively, at least 70%, or at least 80%, or at least 85%, or at least 90%, or at least 95%, or at least 97% of the CE fibers have a DPF within +/−15% of any one of the above stated DPF; or at least 70%, or at least 80%, or at least 85%, or at least 90%, or at least 95%, or at least 97% of the CE fibers have a DPF within +/−10% of any one of the above stated DPF. Desirably, at least 85%, or at least 90%, or at least 95%, or at least 97% of the CE fibers have a DPF within +/−15%, or within +/−10% of any one of the above stated DPF.

In one embodiment or in any of the mentioned embodiments, the DPF can have a small distribution span satisfying the following formula:

$$\frac{d 90 - d 10}{d 50} * 100 \leq S$$

where d is based on the median DPF, d₉₀ is the value at which 90% of the fibers have a DPF less than target DPF, d₁₀ is the value at which 10% of the fibers have a DPF less than the target DPF, d₅₀ is the value at which 50% of the fibers have a DPF less than the target DPF and 50% of fibers have a DPF more than the target DPF, and S is 40%, or 35%, or 30%, or 25%, or 20%, or 15%, or 13%, or 10%, or 8%, or 7%.

The individual cellulose ester filaments discharged from the spinnerette, and the CE fibers, may have any suitable transverse cross-sectional shape. Exemplary cross-sectional shapes include, but are not limited to, round or other than round (non-round). Non-round shapes include Y-shaped or other multi-lobal shapes such as I-shaped (dog bone), closed C-shaped, X-shaped, or crenulated shapes. When a cellulose ester filament, or CE fiber, has a multi-lobal cross-sectional shape, it may have at least 3, or 4, or 5, or 6 or more lobes. In some cases, the filaments may be symmetric along one or more, two or more, three or more, or four or more axes, and, in other embodiments, the filaments may be asymmetrical. As used herein, the term “cross-section” generally refers to the transverse cross-section of the filament measured in a direction perpendicular to the direction of elongation of the filament. The cross-section of the filament may be determined and measured using Quantitative Image Analysis (QIA). Staple fibers will have a cross-section similar to the filaments from which they are formed without mechanically deforming the staple fibers.

In some embodiments, the cross-sectional shape of an individual cellulose ester filament and the CE fibers may be characterized according to its deviation from a round cross-sectional shape. In some cases, this deviation from perfectly round can be characterized by the shape factor of the filament, which is determined by the following formula: Shape Factor=Average Cross-Sectional Perimeter/(4π×Average Cross-Sectional Area)½. The shape factor of filament or CE fibers having a perfect round cross-sectional shape is 1. In some embodiments, the shape factor of the individual cellulose ester filaments or CE fibers is at least about 1, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2. In addition or in the alternative, the shape factor of the cellulose ester filaments and CE fibers is not more than about 5, or not more than 4.8, or not more than 4.75, or not more than 4.5, or not more than 4.25, or not more than 4, or not more than 3.75, or not more than 3.5, or not more than 3.25, or not more than 3, or not more than 2.75, or not more than 2.5, or not more than 2.25, or not more than 2, or not more than 1.75, or not more than 1.5, or not more than 1.25, or not more than 1.2, or not more than 1.15, or not more than 1.1, or not more than 1.05. In one embodiment, the fiber is classified as round. The shape factor can be calculated from the cross-sectional area of a filament, which can be measured using QIA. As used herein, a round shape would have a shape factor of less than 1.25, while a non-round shape would have a shape factor of 1.25 or more.

In one embodiment or in any of the mentioned embodiments, desirably, the shape of the CE fiber is round or crenulated and has a shape factor of at not more than 1.5, or not more than 1.4, or not more than 1.3, or not more than 1.25, or not more than 1.2, or not more than 1.1.5

In one embodiment or in any of the mentioned embodiments, at least 70%, or at least 80%, or at least 85%, or at least 90%, or at least 95%, or at least 97%, or at least 99% of the CE fibers have the stated shape.

After multiple bundles are assembled into a filament yarn (or tow band), it may be passed through a crimping zone wherein a patterned wavelike shape may be imparted to at least a portion, or substantially all, of the individual filaments. In some cases, the filaments may not be crimped, and the uncrimped filaments may be passed directly from the spinnerette to a drying zone. When used, the crimping zone includes at least one crimping device for mechanically crimping the filament yarn. Filament yarns desirably are not crimped by thermal or chemical means (e.g., hot water baths, steam, air jets, or chemical coatings), but instead are mechanically crimped using a suitable crimper. One example of a suitable type of mechanical crimper is a “stuffing box” or “stuffer box” crimper that utilizes a plurality of rollers to generate friction, which causes the fibers to buckle and form crimps. Other types of crimpers may also be suitable. Examples of equipment suitable for imparting crimp to a filament yarn are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, each of which is incorporated herein by reference to the extent not inconsistent with the present disclosure. In some cases, the crimping step may be performed at a rate of at least about 50 m/min (75, 100, 125, 150, 175, 200, 225, 250 m/min) and/or not more than about 750 m/min (475, 450, 425, 400, 375, 350, 325, or 300 m/min).

In one embodiment or in any of the mentioned embodiments, the crimped CE fibers have an average effective length that is not more than 85 percent of the actual length of the crimped CE fibers. The effective length refers to the maximum dimension between any two points of a fiber and the actual length refers the end-to-end length of a fiber if it were perfectly straightened. If a fiber is straight, its effective length is the same as its actual length. However, if a fiber is curved and/or crimped, its effective length will be less than its actual length, where the actual length is the end-to-end length of the fiber if it were perfectly straightened. In one embodiment or in any one of the embodiments described herein, the crimped fibers have an average effective length that is not more than 80, or not more than 75, or not more than 65, or not more than 50, or not more than 40, or not more than 30, or not more than 20 percent of the actual length of the bent fibers.

The low DPF CE fibers can be susceptible to breakage when cut from the filaments, or when further processed, compared to the normal frequency of crimps imparted to higher denier fibers typically used in cigarette filter tow. Crimping is a useful component of the CE fiber to enhance cohesion and entanglement with the cellulosic fibers and with each other. However, given the low DPF of the fibers, a low frequency of crimps is desirable to minimize fiber breakage when the filaments are cut to staple and when they are further processed or handled prior to their combination with the cellulosic fibers, and also to retain a high degree of retained tenacity. As used herein, the term “retained tenacity” refers to the ratio of the tenacity of a crimped filament (or staple fiber) to the tenacity of an identical but uncrimped filament (or staple fiber), expressed as a percent. For example, a crimped fiber having a tenacity of 1.3 gram-force/denier (g/denier) would have a retained tenacity of 87 percent if an identical but uncrimped fiber had a tenacity of 1.5 g/denier.

In one embodiment or in any of the mentioned embodiments, the crimped cellulose ester filaments are capable of having a retained tenacity of at least about 40%, or at least 50%, or at least 60%, or at least 65%, or at least 70%, or at least 75%, or at least 80%, or at least 85%, or at least 90%, or at least 95%.

Crimping may be performed such that the continuous filaments from which the CE fibers are cut and/or the CE fibers themselves have a crimp frequency of at least 5, or at least 7, or at least 10, or at least 12, or at least 13, or at least 15, or at least 17, and up to 30, or up to 27, or up to 25, or up to 23, or up to 20, or up to 19 crimps per inch (CPI), measured according to ASTM D3937-12. Higher than 30 CPI tends to result in excess breakage in the cutting of filaments to staple at the small cut lengths described below, and also reduces their retained tenacity. Desirably, the average CPI of the filaments used to make the CE fibers is a value from 7 to 30 CPI, or 7 to 25 CPI, or 7 to 20 CPI, or 7 to 18 CPI, or 7 to 15 CPI, or 8 to 30 CPI, or 12 to 30 CPI, or 12 to 27 CPI, or 12 to 25 CPI, or 12 to 23 CPI, or 12 to 20 CPI, or 15 to 30 CPI, or 15 to 27 CPI, or 15 to 25 CPI, or 15 to 23 CPI, or 15 to 20 CPI.

In one embodiment or in any of the mentioned embodiments, the ratio of the crimp frequency CPI to DPF can be greater than about 2.75:1, or greater than 2.80:1, or greater than 2.85:1, or greater than 2.90:1, or greater than 2.95:1, or greater than 3.00:1, or greater than 3.05:1, or greater than 3.10:1, or greater than 3.15:1, or greater than 3.20:1, or greater than 3.25:1, or greater than 3.30:1, or greater than 3.35:1, or greater than 3.40:1, or greater than 3.45:1, or greater than 3.50:1. In some cases, this ratio may be even higher, such as, for example, greater than about 4:1, or greater than 5:1, or greater than 6:1, or greater than or greater than 7:1 particularly when, for example, the fibers being crimped are relatively fine.

When crimped, the crimp amplitude of the fibers may vary and can, for example, be at least about 0.85, or at least 0.90, or at least 0.93, or at least 0.96, or at least 0.98, or at least 1.00, or at least 1.04 mm. Additionally, or in the alternative, the crimp amplitude of the fibers can be up to 1.75, or up to 1.70, or up to 1.65, or up to 1.55, or up to 1.35, or up to 1.28, or up to 1.24, or up to 1.15, or up to 1.10, or up to 1.03, or up to 0.98 mm.

The CE fibers may be crimped or uncrimped. After crimping (or, if not crimped, after spinning), the fibers may further be dried in a drying zone in order to reduce the moisture and/or solvent content of the filament yarn or tow band. A dry CE fiber will have a moisture content of not more than 30 wt. % moisture, or not more than 25 wt. % moisture, as determined by oven dryness. The final moisture content, or level of dryness, of the filament yarn (or tow band), and of the CE fibers, particularly between cutting and combining with other fibers can be less than 1 wt. %, and desirably is at least about 1 wt. %, or at least 2 wt. %, or at least 3 wt. %, or at least 3.5 wt. %, or at least 4 wt. %, or at least 4.5 wt. %, or at least 5 wt. %, or at least 5.5 wt. %, or at least 6 wt. %, based on the total weight of the yarn or staple fibers and/or not more than about 20 wt. %, or not more than 18 wt. %, or not more than 16 wt. %, or not more than 13 wt. %, or not more than 10 wt. %, or not more than 9 wt. %, or not more than 8 wt. %, or not more than 7 wt. %, or not more than 6.5 wt. %, based on the weight of the filament yarn, as determined by oven dryness. Suitable ranges include, but are not limited to, 3-20, or 3-18, or 3-16, or 3-13, or 3-10, or 3-9, or 3-8, or 3-7, or 3-6.5, or 4-20, or 4-18, or 4-16, or 4-13, or 4-10, or 4-9, or 4-8, or 4-7, or 4-6.5, or 5-20, or 5-18, or 5-16, or 5-13, or 5-10, or 5-9, or 5-8, or 5-7, or 5.5-20, or 5.5-18, or 5.5-16, or 5.5-13, or 5.5-10, or 5.5-9, or 6-20, or 6-18, or 6-16, or 6-13, or 6-10, in each case as wt. % based on the weight of the CE fiber.

In another embodiment or in any one of the mentioned embodiments, the CE fibers, prior to or upon their combination with other fibers, have no liquid added to them and/or their moisture content is the equilibrium moisture of the surrounding non-moisture-controlled environment.

The CE fibers have the advantage of not requiring their maintenance as a slurry or emulsion (e.g. greater than 30 wt. % water) during shipping as well as reducing shipping weight and its associated costs. Any suitable type of dryer can be used such as, for example, a forced air oven, a drum dryer, or a heat setting channel. The dryer may be operated at any temperature and pressure conditions that provide the requisite level of drying without damaging the yarn.

The fiber to fiber coefficient of dynamic friction (“F/F CODF”) and the fiber to metal coefficient of dynamic friction (“F/M CODF”) can be influenced by the application of a finish on the filaments used to make the CE fibers and present on the CE fibers. A finish applied to the CE filaments, also called “fiber finish” or “spin finish,” refers to any suitable type of coating that, when applied to a fiber filament modifies friction exerted by and on the fiber, and alters the ability of the fibers to move relative to one another and/or relative to a metal surface. Finishes are not the same as adhesives, bonding agents, or other similar chemical additives which, when added to fibers, prevent movement between the fibers by adhering them to one another. Finishes, when applied, continue to permit the movement of the fibers relative to one another and/or relative to other surfaces while modifying the ease of this movement by increasing or decreasing the frictional forces.

In one or any of the embodiments mentioned, if a spin finish is applied to the filaments and/or present on the CE fibers, the finish decreases the F/F CODF and/or the F/M CODF, relative to the same fiber without a finish. A finish which decreases the F/F CODF and/or F/M CODF on the fibers can decrease the potential for the fibers to agglomerate or flocculate with each other or to decrease the potential of the fibers to agglomerate on metal surfaces.

The CE fibers may exhibit a fiber-to-fiber staple pad friction coefficient of friction of at least about 0.10, 0.15, 0.20, 0.25, 0.30, 0.35, 0.40, 0.45, or 0.50 and/or not more than about 1, 0.95, 0.90, 0.85, 0.80, 0.75, 0.70, 0.65, 0.60, 0.55, or 0.50, measured as described in U.S. Pat. No. 5,863,811, the entire disclosure of which is incorporated herein by reference to the extent not inconsistent with the present disclosure. Additionally, or in the alternative, the CE fibers may exhibit a fiber-to-metal staple pad friction coefficient of friction of at least about 0.10, 0.15, 0.20, or 0.25 and/or not more than about 0.55, 0.50, 0.45, 0.40, 0.35, or 0.30, measured as described in U.S. Pat. No. 5,683,811. In some cases, the CE fibers may exhibit a F/F coefficient of dynamic friction (“F/F CODF”), measured on the filament yarn from which they are cut according to ASTM D3412, of at least about 0.01, 0.02, 0.03, 0.04, 0.05, or 0.06 or 0.1, or 0.11, or 0.12, or 0.13 and/or not more than about 0.20, or 0.18, or 0.15, 0.14, 0.13, 0.12, 0.11, 0.10, 0.09, 0.08, 0.07, or 0.06.

In one or any of the embodiments mentioned, the CE fibers can have an untwisted F/F CODF (also called a fiber to fiber sliding friction) between 0.11 to 0.20 as measured by ASTM D3412/3412M-13 on the filament yarn from which they are cut. To determine the F/F CODF of the filaments, the continuous filaments are conditioned at 70° F. and 65% relative humidity for 24 hours before testing. The filament yarn is measured according to ASTM D3412/3412M-13, with the exception that only 1 twist is used, the rate is at 20 m/min, and the yarn is tested on a Constant Tension Transport with Electronic Drive (CTT-E) at an input tension of 10 grams. The values obtained by this method are deemed to be the F/F CODF of the CE fibers. The F/F CODF can be from 0.11 to 0.20, or from 0.11 to less than 0.20, or from 0.11 to 0.19, or from 0.11 to 0.18, or from 0.11 to 0.17, or from 0.11 to 0.16, or from 0.11 to 0.15, or from 0.12 to 0.20, or from 0.12 to less than 0.20, or from 0.12 to 0.19, or from 0.12 to 0.18, or from 0.12 to 0.17, or from 0.12 to 0.16, or from 0.12 to 0.15.

Desirably, the F/M CODF is not more than 0.70, or not more than 0.65, or not more than 0.60, or not more than 0.59, or not more than 55, or not more than 0.52, or nor more than 0.50, or not more than 0.48, or not more than 0.47. Desirable ranges include 0.30 to 0.80, or 0.30 to 0.70, or 0.30 to 0.65, or 0.30 to 0.60, or 0.40 to 0.80, or 0.40 to 0.70, or 0.40 to 0.65, or 0.40 to 0.60, or 0.45 to 0.80, or 0.45 to 0.70, or 0.45 to 0.65, or 0.45 to 0.60, or 0.48 to 0.80, or 0.48 to 0.70, or 0.48 to 0.65, or 0.48 to 0.60, or 0.50 to 0.80, or 0.50 to 0.70, or 0.50 to 0.65, or 0.50 to 0.60.

In the case one applies an anti-static finish, the CE fibers can have a static electricity charge of less than 1.0 at 65% relative humidity. The test method for determining the static electricity charge of the CE fibers is as follows. The sample is a filament yarn used to make the staple fibers. The filament yarn is exposed to a controlled environment at 65% relative humidity at 70° F. for 24 hours to condition the filament yarn. A two (2) foot section of the filament yarn is secured at one end, the other end is held by hand while rubbing the secured section of the filament yarn back and forth along the whole 2-foot section for 3 cycles using the side of a wooden #2 pencil. The static electricity charge imparted to the filaments are measured using a Simco Electrostatic Fieldmeter Model FMX-003 or equivalent device. The static electricity charge on the CE fibers, measured as noted above, can be no more than 1.0, or no more than 0.98, or no more than 0.96, or no more than 0.90, or no more than 0.85, or no more than 0.80, or no more than 0.78, or no more than 0.75, or no more than 0.70, or no more than 0.68, or no more than 0.58, or no more than 0.60, or no more than 0.58, or no more than 0.55, or no more than 0.50.

Any suitable method of applying a finish may be used and can include, for example, spraying, wick application, dipping, or use of squeeze, lick, or kiss rollers.

When used, the finishes may be of any suitable type and can be present on the filaments, filament yarns, tow bands, CE fibers, and CE fibers present in fabrics and molded articles. Suitable amounts of finish on the CE fibers can be at least about 0.01, or at least 0.02, or at least 0.05, or at least 0.10, or at least 0.15, or at least 0.20, or at least 0.25, or at least 0.30, or at least 0.35, or at least 0.40, or at least 0.45, or at least 0.50, or at least 0.55, or at least 0.60 percent finish-on-yarn (FOY) relative to the weight of the dried CE fiber. Alternatively, or in addition, the cumulative amount of finish may be present in an amount of not more than about 2.5, or not more than 2.0, or not more than 1.5, or not more than 1.2, or not more than 1.0, or not more than 0.9, or not more than 0.8, or not more than 0.7 percent finish-on-yarn (FOY) based on the total weight of the dried fiber. The amount of finish on the fibers as expressed by weight percent may be determined by solvent extraction. As used herein “FOY” or “finish on yarn” refers to the amount of finish on the yarn less any added water. If a finish is applied, the desired cumulative amount of finish on the fibers is from 0.10 to 1.0, or 0.10 to 0.90, or 0.10 to 0.80, or 0.10 to 0.70, or 0.15 to 1.0, or 0.15 to 0.90, or 0.15 to 0.80, or 0.15 to 0.70, or 0.20 to 1.0, or 0.20 to 0.90, or 0.20 to 0.80, or 0.20 to 0.70, or 0.25 to 1.0, or 0.25 to 0.90, or 0.25 to 0.80, or 0.25 to 0.70, or 0.30 to 1.0, or 0.30 to 0.90, or 0.30 to 0.80, or 0.30 to 0.70, each as % FOY.

The CE fibers and the fabrics and molded articles containing the CE fibers can include little or no plasticizer. In some embodiments, the CE fibers or the fabrics and molded articles, or the combination thereof, contain not more than, or have added not more than, 5, or not more than 4.5, or not more than 4, or not more than 3.5, or not more than 3, or not more than 2.5, or not more than 2, or not more than 1.5, or not more than 1, or not more than 0.5, or not more than 0.25, or not more than 0.10, or nor more than 0.05, or not more than 0.01 wt. % plasticizer, based on the total weight of the CE fibers. When present, the plasticizer may be incorporated into the fiber itself by being blended with the solvent dope or cellulose ester flake, or the plasticizer may be applied to the surface of the fiber or filament by spraying, by centrifugal force from a rotating drum apparatus, or by an immersion bath.

Plasticizers are compounds that can decrease the glass transition temperature of a polymer. Examples of plasticizers that are either not present or added to the CE fibers before refining (plasticizers can be added post blending to the furnish), or not present in or added to the filaments from which the CE fibers are derived, or if present are in low amounts, include, but are not limited to, aromatic polycarboxylic acid esters, aliphatic polycarboxylic acid esters, lower fatty acid esters of polyhydric alcohols, and phosphoric acid esters. Further examples can include, but are not limited to, the phthalate acid acetates such as dimethyl phthalate, diethyl phthalate, dibutyl phthalate, dihexyl phthalate, dioctyl phthalate, dimethoxyethyl phthalate, ethyl phthalylethyl glycolate, butyl phthalylbutyl glycolate, levulinic acid esters, dibutyrates of triethylene glycol, tetraethylene glycol, pentaethylene glycol, tetraoctyl pyromellitate, trioctyl trimellitate, dibutyl adipate, dioctyl adipate, dibutyl sebacate, dioctyl sebacate, diethyl azelate, dibutyl azelate, dioctyl azelate, glycerol, trimethylolpropane, pentaerythritol, sorbitol, glycerin, glycerin (or glyceryl) triacetate (triacetin), diglycerin tetracetate, triethyl phosphate, tributyl sebacate, triethyl phosphate, tributyl phosphate, tributoxyethyl phosphate, triphenyl phosphate, and tricresyl phosphate, diethyl citrate, triethyl citrate, polyethylene glycol, polyethylene adipate, polyethylene succinate, polypropylene glycol, polyglycolic acid, polybutylene adipate, polycaprolactone, polypropiolactone, valerolactone, polyvinylpyrrolidone, and other plasticizers having a weight average molecular weight of 200 to 800.

The amount of plasticizer added to or present on or in the CE fibers prior to combining with other fibers is either zero or not more than 2 wt. %, or not more than 1 wt. %, or not more than 0.9 wt. %, or not more than 0.8 wt. %, or not more than 0.7 wt. %, or not more than 0.6 wt. %, or not more than 0.5 wt. %, or not more than 0.4 wt. %, or not more than 0.3 wt. %, or not more than 0.2 wt. %, or not more than 0.1 wt. %, or not more than 0.09 wt. %, or not more than 0.07 wt. %, or not more than 0.05 wt. %, or not more than 0.03 wt. %, or not more than 0.01 wt. %, or not more than 0.007 wt. %, or not more than 0.005 wt. %, or not more than 0.003 wt. %, or not more than 0.001 wt. %, or not more than 0.0007 wt. %, based in each case either as FOY, or based on the weight of the CE fibers, or both.

In one embodiment or in any or all of the embodiments mentioned, the CE fiber has a continuous matrix or phase of cellulose ester throughout its cross section, and in another embodiment, the CE fiber is uniformly cellulose ester, and in yet another embodiment, is also uniformly chemically homogenous. In addition, or alternatively, the CE fiber contains more than 96 wt. %, or at least 97 wt. %, or at least 98 wt. %, or at least 99 wt. %, or 100 wt. % cellulose ester polymer based on the weight of the fiber. For example, the CE fiber desirably does not have a core/sheath structure. The CE polymers used to make the CE fibers, and the CE fibers, are desirably not chemically treated to alter the chemical structure of the cellulose ester upon or after the cellulose ester is spun into the filament that is used to cut to form the CE fiber, such as to increase the hydroxyl number of the CE fiber. For example, the CE fibers desirably are not surface hydrolyzed. Surface hydrolysis can increase the number of —OH sites on a cellulose ester to thereby increase hydrogen bonding with cellulose. Such a process, however, adds extra processing steps and is economically impractical. In embodiments where the CE fibers are not surface hydrolyzed, for avoidance of doubt, it is meant that they are not surface hydrolyzed when they are present as a fiber, whether as an isolated fiber, as present with other fiber, when made into a furnish.

The amount of CE fibers in the fabric used to make the molded article, or the amount of CE fibers in the molded article, can be at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 90 wt. %, based on the weight of the fabric or the molded article. In an embodiment, the amount CE fibers is more than 50 wt. %, or more than 60 wt. %, or at least 70 wt. %, or at least 75 wt. %, based on the weight of the fabric or the molded article.

The amount of CE fibers in the fabric used to make the molded article, or the amount of CE fibers in the molded article, can be at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 90 wt. %, based on the combined weight of weight of elastane (spandex) and CE fibers in a fabric or a molded article.

The amount of CE fibers in the fabric used to make the molded article, or the amount of CE fibers in the molded article, can be at least 35 wt. %, or at least 40 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 90 wt. %, based on the combined weight of weight of all thermoplastic fibers in a fabric or a molded article.

In another embodiment or in any of described embodiments, the CE fibers, and/or the fabrics or molded articles containing the CE fibers, are biodegradable, meaning that such CE fibers are expected to decompose under certain environmental conditions. The degree of degradation can be characterized by the weight loss of a sample over a given period of exposure to certain environmental conditions. In some cases, the cellulose ester polymer used to form the staple fibers, the fibers, or fabrics and molded articles can exhibit a weight loss of at least about 5, 10, 15, or 20 percent after burial in soil for 60 days and/or a weight loss of at least about 15, 20, 25, 30, or 35 percent after 15 days of exposure in a composter. However, the rate of degradation may vary depending on the particular end use of the fibers. Exemplary test conditions are provided in U.S. Pat. Nos. 5,870,988 and 6,571,802, incorporated herein by reference.

The CE fibers can meet or exceed passing standards set by international test methods and authorities for industrial compostability, home compostability, and/or soil biodegradability.

To be considered “compostable,” a material must meet the following four criteria: (1) the material must be biodegradable; (2) the material must be disintegrable; (3) the material must not contain more than a maximum amount of heavy metals; and (4) the material must not be ecotoxic. As used herein, the term “biodegradable” generally refers to the tendency of a material to chemically decompose under certain environmental conditions.

Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one embodiment or in any of the mentioned embodiments, the CE fibers, and the fabrics or molded articles containing the CE fibers, are industrially compostable, home compostable, or both, and can satisfy four criteria:
1) biodegrade in that at least 90% carbon content is converted within 180 days;
2) disintigratable in that least 90% the material disintegrates within 12 weeks;
3) does not contain heavy metals beyond the thresholds established under the EN12423 standard; and
4) the disintegrated content supports future plant growth as humus; where each of these four conditions are tested per the ASTM D6400, or ISO 17088, or EN 13432 method.

The CE fibers, and/or the fabrics and molded articles made thereby can exhibit a biodegradation of at least 70 percent in a period of not more than 50 days, when tested under aerobic composting conditions at ambient temperature (28° C.±2° C.) according to ISO 14855-1 (2012). In some cases, the CE fibers, and/or the fabrics and molded articles made thereby, can exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some cases, the CE fibers, and/or the fabrics and molded articles made thereby, can exhibit a total biodegradation of at least about 71, or at least 72, or at least 73, or at least 74, or at least 75, or at least 76, or at least 77, or at least 78, or at least 79, or at least 80, or at least 81, or at least 82, or at least 83, or at least 84, or at least 85, or at least 86, or at least 87, or at least 88 percent, when tested under according to ISO 14855-1 (2012) for a period of 50 days under home composting conditions. This may represent a relative biodegradation of at least about 95, or at least 97, or at least 99, or at least 100, or at least 101, or at least 102, or at least 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The CE fibers, and the products made thereby, may exhibit a biodegradation of at least 90 percent within not more than 1 year, measured according 14855-1 (2012) under home composting conditions. In some cases, the CE fibers, and/or the fabrics and molded articles made thereby, may exhibit a biodegradation of at least about 91, or at least 92, or at least 93, or at least 94, or at least 95, or at least 96, or at least 97, 9 or at least 8, or at least 99, or at least 99.5 percent within not more than 1 year, or the fibers may exhibit 100 percent biodegradation within not more than 1 year, measured according 14855-1 (2012) under home composting conditions.

Additionally, or in the alternative, the CE fibers, and/or the fabrics and molded articles made thereby, may exhibit a biodegradation of at least 90 percent within not more than about 350, or not more than 325, or not more than 300, or not more than 275, or not more than 250, or not more than 225, or not more than 220, or not more than 210, or not more than 200, or not more than 190, or not more than 180, or not more than 170, or not more than 160, or not more than or not more than 150, or not more than 140, or not more than 130, or not more than 120, or not more than 110, or not more than 100, or not more than 90, or not more than 80, or not more than 70, or not more than 60, or not more than 50 days, measured according 14855-1 (2012) under home composting conditions. In some cases, the CE fibers, and/or the fabrics and molded articles made thereby, can be at least about 97, or at least 98, or at least 99, or at least 99.5 percent biodegradable within not more than about 70, or not more than 65, or not more than 60, or not more than 50 days of testing according to ISO 14855-1 (2012) under home composting conditions. As a result, the CE fibers, and/or the fabrics and molded articles made thereby may be considered biodegradable according to, for example, French Standard NF T 51-800 and Australian Standard AS 5810 when tested under home composting conditions.

The CE fibers, and/or the fabrics and molded articles made thereby can exhibit a biodegradation of at least 60 percent in a period of not more than 45 days, when tested under aerobic composting conditions at a temperature of 58° C. (±2° C.) according to ISO 14855-1 (2012). In some cases, they can exhibit a biodegradation of at least 60 percent in a period of not more than 44, or not more than 43, or not more than 42, or not more than 41, or not more than 40, or not more than 39, or not more than 38, or not more than 37, or not more than 36, or not more than 35, or not more than 34, or not more than 33, or not more than 32, or not more than 31, or not more than 30, or not more than 29, or not more than 28, or not more than 27 days when tested under these conditions, also called “industrial composting conditions.” These may not be aqueous or anaerobic conditions. In some cases, the CE fibers, and/or the fabrics and molded articles made thereby can exhibit a total biodegradation of at least about 65, or at least 70, or at least 75, or at least 80, or at least 85, or at least 87, or at least 88, or at least 89, or at least 90, or at least 91, or at least 92, or at least 93, or at least 94, or at least 95 percent, when tested under according to ISO 14855-1 (2012) for a period of 45 days under industrial composting conditions. This may represent a relative biodegradation of at least about 95, or at least 97, or at least 99, or at least 100, or at least 102, or at least 105, or at least 107, or at least 110, or at least 112, or at least 115, or at least 117, or at least 119 percent, when compared to cellulose fibers subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide within 180 days. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The CE fibers, and/or the fabrics and molded articles made thereby may exhibit a biodegradation of at least 90 percent within not more than 180 days, measured according 14855-1 (2012) under industrial composting conditions. In some cases, the CE fibers, and/or the fabrics and molded articles made thereby may exhibit a biodegradation of at least about 91, or at least 92, or at least 93, or at least 94, or at least 95, or at least 96, or at least 97, or at least 98, or at least 99, or at least 99.5 percent within not more than 180 days, or the fibers may exhibit 100 percent biodegradation within not more than 180 days, measured according 14855-1 (2012) under industrial composting conditions.

Additionally, or in the alternative, the CE fibers, and/or the fabrics and molded articles made thereby may exhibit a biodegradation of least 90 percent within not more than about 175, or not more than 170, or not more than 165, or not more than 160, or not more than 155, or not more than 150, or not more than 145, or not more than 140, or not more than 135, or not more than 130, or not more than 125, or not more than 120, or not more than 115, or not more than 110, or not more than 105, or not more than 100, or not more than 95, or not more than 90, or not more than 85, or not more than 80, or not more than 75, or not more than 70, or not more than 65, or not more than 60, or not more than 55, or not more than 50, or not more than 45 days, measured according 14855-1 (2012) under industrial composting conditions. In some cases, the CE fibers, and/or the fabrics and molded articles made thereby can be at least about 97, 98, 99, or 99.5 percent biodegradable within not more than about 65, or not more than 60, or not more than 55, or not more than 50, or not more than 45 days of testing according to ISO 14855-1 (2012) under industrial composting conditions. As a result, the CE fibers, and/or the fabrics and molded articles made thereby may be considered biodegradable according ASTM D6400 and ISO 17088 when tested under industrial composting conditions.

The CE fibers, and/or the fabrics and molded articles made thereby may exhibit a soil biodegradation of at least 60 percent within not more than 130 days, measured according to ISO 17556 (2012) under aerobic conditions at ambient temperature. In some cases, the CE fibers, and/or the fabrics and molded articles made thereby can exhibit a biodegradation of at least 60 percent in a period of not more than 130, or not more than 120, or not more than 110, or not more than 100, or not more than 90, or not more than 80, or not more than 75 days when tested under these conditions, also called “soil composting conditions.” These may not be aqueous or anaerobic conditions. In some cases, the CE fibers, and/or the fabrics and molded articles made thereby can exhibit a total biodegradation of at least about 65, or at least 70, or at least 72, or at least 75, or at least 77, or at least 80, or at least 82, or at least 85 percent, when tested under according to ISO 17556 (2012) for a period of 195 days under soil composting conditions. This may represent a relative biodegradation of at least about 70, or at least 75, or at least 80, or at least 85, or at least 90, or at least 95 percent, when compared to cellulose fibers subjected to identical test conditions.

In order to be considered “biodegradable,” under soil composting conditions according the OK biodegradable SOIL conformity mark of Vingotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years. The CE fibers, and/or the fabrics and molded articles made thereby may exhibit a biodegradation of at least 90 percent within not more than 2 years, 1.75 years, 1 year, 9 months, or 6 months measured according ISO 17556 (2012) under soil composting conditions. In some cases, the CE fibers, and/or the fabrics and molded articles made thereby may exhibit a biodegradation of at least about 91, or at least 92, or at least 93, or at least 94, or at least 95, or at least 96, or at least 97, or at least 98, or at least 99, or at least 99.5 percent within not more than 2 years, or the fibers may exhibit 100 percent biodegradation within not more than 2 years, measured according ISO 17556 (2012) under soil composting conditions.

Additionally, or in the alternative, CE fibers, and/or the fabrics and molded articles made thereby may exhibit a biodegradation of at least 90 percent within not more than about 700, 650, 600, 550, 500, 450, 400, 350, 300, 275, 250, 240, 230, 220, 210, 200, or 195 days, measured according 17556 (2012) under soil composting conditions. In some cases, the CE fibers, and/or the fabrics and molded articles made thereby can be at least about 97, or at least 98, or at least 99, or at least 99.5 percent biodegradable within not more than about 225, or not more than 220, or not more than 215, or not more than 210, or not more than 205, or not more than 200, or not more than 195 days of testing according to ISO 17556 (2012) under soil composting conditions. As a result, the CE fibers, and/or the fabrics and molded articles made thereby may meet the requirements to receive The OK biodegradable SOIL conformity mark of Vingotte and to meet the standards of the DIN Geprüft Biodegradable in soil certification scheme of DIN CERTCO.

In some cases, CE fibers, and/or the fabrics and molded articles made thereby may include less than 1, or not more than 0.75, or not more than 0.50, or not more than 0.25 weight percent of components of unknown biodegradability, based on the weight of the CE fiber. In some cases, the fibers, fabrics, or articles described herein may include no components of unknown biodegradability.

In addition to the CE fibers being biodegradable under industrial and/or home composting conditions, the fabrics and molded articles may also be compostable under home and/or industrial conditions. As described previously, a material is considered compostable if it meets or exceeds the requirements set forth in EN 13432 for biodegradability, ability to disintegrate, heavy metal content, and ecotoxicity. The CE fibers may exhibit sufficient compostability under home and/or industrial composting conditions to meet the requirements to receive the OK compost and OK compost HOME conformity marks from Vingotte.

In some cases, the CE fibers, and the products made thereby, may have a volatile solids concentration, heavy metals and fluorine content that fulfill all of the requirements laid out by EN 13432 (2000). Additionally, the CE fibers may not cause a negative effect on compost quality (including chemical parameters and ecotoxicity tests).

In some cases, the CE fibers, and/or the fabrics and molded articles made thereby can exhibit a disintegration of at least 90 percent within not more than 26 weeks, measured according to ISO 16929 (2013) under industrial composting conditions. In some cases, the fibers, fabrics, or molded articles may exhibit a disintegration of at least about 91, or at least 92, or at least 93, or at least 94, or at least 95, or at least 96, or at least 97, or at least 98, or at least 99, or at least 99.5 percent under industrial composting conditions within not more than 26 weeks, or the fibers or fabrics, or molded articles may be 100 percent disintegrated under industrial composting conditions within not more than 26 weeks. Alternatively, or in addition, the CE fibers, and/or the fabrics and molded articles made thereby may exhibit a disintegration of at least 90 percent under industrial compositing conditions within not more than about 26, or not more than 25, or not more than 24, or not more than 23, or not more than 22, or not more than 21, or not more than 20, or not more than 19, or not more than 18, or not more than 17, or not more than 16, or not more than 15, or not more than 14, or not more than 13, or not more than 12, or not more than 11, or not more than 10 weeks, measured according to ISO 16929 (2013). In some cases, the CE fibers, and/or the fabrics and molded articles made thereby may be at least 97, or at least 98, or at least 99, or at least 99.5 percent disintegrated within not more than 12, or not more than 11, or not more than 10, or not more than 9, or not more than 8 weeks under industrial composting conditions, measured according to ISO 16929 (2013).

In some cases, the CE fibers, and/or the fabrics and molded articles made thereby can exhibit a disintegration of at least 90 percent within not more than 26 weeks, measured according to ISO 16929 (2013) under home composting conditions. In some cases, the CE fibers, and/or the fabrics and molded articles made thereby may exhibit a disintegration of at least about 91, or at least 92, or at least 93, or at least 94, or at least 95, or at least 96, or at least 97, or at least 98, or at least 99, or at least 99.5 percent under home composting conditions within not more than 26 weeks, or the fibers or fabrics, or molded articles may be 100 percent disintegrated under home composting conditions within not more than 26 weeks. Alternatively, or in addition, the CE fibers, and/or the fabrics and molded articles made thereby may exhibit a disintegration of at least 90 percent within not more than about 26, or not more than 25, or not more than 24, or not more than 23, or not more than 22, or not more than 21, or not more than 20, or not more than 19, or not more than 18, or not more than 17, or not more than 16, or not more than 15 weeks under home composting conditions, measured according to ISO 16929 (2013). In some cases, the CE fibers, and/or the fabrics and molded articles made thereby may be at least 97, or at least 98, or at least 99, or at least 99.5 percent disintegrated within not more than 20, or not more than 19, or not more than 18, or not more than 17, or not more than 16, or not more than 15, or not more than 14, or not more than 13, or not more than 12 weeks, measured under home composting conditions according to ISO 16929 (2013).

The CE fibers, and/or the fabrics and molded articles made thereby can achieve higher levels of biodegradability and/or compostability without use of additives that have traditionally been used to facilitate environmental non-persistence of similar fibers. Such additives can include, for example, photodegradation agents, biodegradation agents, decomposition accelerating agents, and various types of other additives. Despite being substantially free of these types of additives, the CE fibers, and/or the fabrics and molded articles made thereby have been found to exhibit enhanced biodegradability and compostability when tested under industrial, home, and/or soil conditions, as discussed previously.

In some embodiments, the CE fibers, and/or the fabrics and molded articles made thereby may be substantially free of photodegradation agents added after the CE fibers are combined with cellulose fibers, or added during or after cellulose fibers have been hydropulped in a stock preparation zone. Optionally, the CE fibers themselves or the fabrics and molded articles may contain not more than about 1, or not more than 0.75, or not more than 0.50, or not more than 0.25, or not more than 0.10, or not more than 0.05, or not more than 0.025, or not more than 0.01, or not more than 0.005, or not more than 0.0025, or not more than 0.001 weight percent of photodegradation agent, based on the total weight of the fiber, or the CE fibers may include no photodegradation agents. Examples of such photodegradation agents include, but are not limited to, pigments which act as photooxidation catalysts and are optionally augmented by the presence of one or more metal salts, oxidizable promoters, and combinations thereof. Pigments can include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

In some embodiments, the CE fibers, and/or the fabrics and molded articles made thereby may be substantially free of biodegradation agents and/or decomposition agents. For example, the CE fibers, and/or the fabrics and molded articles made thereby may include not more than about 1, or not more than 0.75, or not more than 0.50, or not more than 0.25, or not more than 0.10, or not more than 0.05, or not more than 0.025, or not more than 0.01, or not more than 0.005, or not more than 0.0025, or not more than 0.0020, or not more than 0.0015, or not more than 0.001, or not more than 0.0005 weight percent of biodegradation agents and/or decomposition agents, based on the total weight of the fiber, or the fibers may include no biodegradation and/or decomposition agents. Examples of such biodegradation and decomposition agents include, but are not limited to, salts of oxygen acid of phosphorus, esters of oxygen acid of phosphorus or salts thereof, carbonic acids or salts thereof, oxygen acids of phosphorus, oxygen acids of sulfur, oxygen acids of nitrogen, partial esters or hydrogen salts of these oxygen acids, carbonic acid and its hydrogen salt, sulfonic acids, and carboxylic acids.

Other examples of such biodegradation and decomposition agents include an organic acid selected from the group consisting of oxo acids having 2 to 6 carbon atoms per molecule, saturated dicarboxylic acids having 2 to 6 carbon atoms per molecule, and lower alkyl esters of said oxo acids or said saturated dicarboxylic acids with alcohols having from 1 to 4 carbon atoms. Biodegradation agents may also comprise enzymes such as, for example, a lipase, a cellulase, an esterase, and combinations thereof. Other types of biodegradation and decomposition agents can include cellulose phosphate, starch phosphate, calcium secondary phosphate, calcium tertiary phosphate, calcium phosphate hydroxide, glycolic acid, lactic acid, citric acid, tartaric acid, malic acid, oxalic acid, malonic acid, succinic acid, succinic anhydride, glutaric acid, acetic acid, and combinations thereof.

The CE fibers, and/or the fabrics and molded articles made thereby may also be substantially free of several other types of additives that have been added to other synthetic fibers to encourage environmental non-persistence. Examples of these additives can include, but are not limited to, polyesters, including aliphatic and low molecular weight (e.g., less than 5000) polyesters, enzymes, microorganisms, water soluble polymers, water-dispersible additives, nitrogen-containing compounds, hydroxy-functional compounds, oxygen-containing heterocyclic compounds, sulfur-containing heterocyclic compounds, anhydrides, monoepoxides, and combinations thereof. In some cases, the CE fibers, and/or the fabrics and molded articles made thereby may include not more than about 0.5, or not more than 0.4, or not more than 0.3, or not more than 0.25, or not more than 0.1, or not more than 0.075, or not more than 0.05, or not more than 0.025, or not more than 0.01, or not more than 0.0075, or not more than 0.005, or not more than 0.0025, or not more than 0.001 weight percent of these types of additives, based on the weight of the CE fibers, or based on the weight of all fibers. The CE fibers may be free of the addition of any of these types of additives.

In an example, a CE fiber, fabrics, or molded articles laid can be compostable in industrial environment (in accordance with EN 13432 or ASTM D6400) meeting the following four criteria:
1. Biodegradation determined by measuring the carbon dioxide produced by the sample under controlled composting conditions following ISO 14855-1:2012, where the sample is mixed with compost and placed in a bioreactor at 58° C. under continuous flow of humidified air. At the exit, the CO₂ concentration is measured and related to the theoretical amount that could be produced regarding the carbon content of the sample.
2. Disintegration as evaluated on a pilot-scale by simulating a real composting environment following ISO 16929:2013, where the samples in their final form are mixed with fresh artificial bioresidue. Oxygen concentration, temperature and humidity are regularly controlled. After 12 weeks, the resulting composts are sieved and the remaining amount of material in pieces >2 mm, if any, is determined.
3. Ecotoxicity of the resulting compost is evaluated in plants following OECD 208 (2006), where the sample material in powder form is added to a bioreactor with fresh bioresidue following the same procedure as in the disintegration test. A comparison is made with the compost resulting from blank bioreactors and bioreactors containing the material tested with regards to plant seedling emergence and growth. Both parameters higher than 90% with respect to the blank compost passes the test.
4. Lacking metals, where each product is identified and characterized including at least: Information and identification of the constituents, presence of regulated metals (Zn, Cu, Ni, Cd, Pb, Hg, Cr, Mo, Se, As, Co) and other hazardous substances to the environment (F), and content in total dry and volatile solids.

The fabrics and molded articles described in embodiment can also be compostable in industrial and backyard or home composting conditions.

Compostability of CE fibers with a DS of 2.5 or below can be achieved without adding any biodegradation and decomposition agents, e.g. hydrolysis assistant or any intentional degradation promoter additives.

The fabrics and molded articles can be biodegradable in soil medium in accordance with ISO 17556:2003 testing protocol.

If desired, biodegradation and decomposition agents, e.g. hydrolysis assistant or any intentional degradation promoter additives can be added to a fabric or be contained within the CE fibers. The decomposition agent can be chosen in such a way that it does not impact the article shelf-life or does not impact the plant-growth when it is a part of the soil. Those additives can promote hydrolysis by releasing acidic or basic residues, and/or accelerate photo or oxidative degradation and/or promote the growth of selective microbial colony to aid the disintegration and biodegradation in compost and soil medium. In addition to promoting the degradation, these additives can have an additional function such as improving the processability of the article or improving mechanical properties.

Examples of decomposition agents include inorganic carbonate, synthetic carbonate, nepheline syenite, talc, magnesium hydroxide, aluminum hydroxide, diatomaceous earth, natural or synthetic silica, calcined clay, and the like. If used, it is desirable that these fillers are dispersed well in the polymer matrix. The fillers can be used singly, or in a combination of two or more.

Examples of aromatic ketones used as an oxidative decomposition agent include benzophenone, anthraquinone, anthrone, acetylbenzophenone, 4-octylbenzophenone, and the like. These aromatic ketones may be used singly, or in a combination of two or more.

Examples of the transition metal compound used as an oxidative decomposition agent include salts of cobalt or magnesium, preferably aliphatic carboxylic acid (C12 to C20) salts of cobalt or magnesium, and more preferably cobalt stearate, cobalt oleate, magnesium stearate, and magnesium oleate. These transition metal compounds can be used singly, or in a combination of two or more.

Examples of rare earth compounds used as an oxidative decomposition agent include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium Sulfate, ceric ammonium nitrate, cerium acetate, lanthanum nitrate, cerium chloride, cerium nitrate, cerium hydroxide, cerium octylate, lanthanum oxide, yttrium oxide, Scandium oxide, and the like. These rare earth compounds may be used singly, or in a combination of two or more.

Examples of basic additives selected can be at least one basic additive is selected from the group consisting of alkaline earth metal oxides, alkaline earth metal hydroxides, alkaline earth metal carbonates, alkali metal carbonates, alkali metal bicarbonates, ZηO and basic Al2O3. Preferably, the at least one basic additive is selected from the group consisting of MgO, Mg(OH)2, MgCO3, CaO, Ca(OH)2, CaCO3, NaHCO₃, Na2CO3, K2CO3, ZηO KHCO3 and basic Al2O3. In another preferred aspect, the at least one basic additive is selected from the group consisting of MgO, Mg(OH)2, MgCO3, CaO, Ca(OH)2, NaHCO₃, K2CO3, ZηO, KHCO3 and basic Al2O3. More preferably, the at least one basic additive is selected from the group consisting of MgO, Mg(OH)2, CaO, Ca(OH)2, ZηO, and basic Al203. In one aspect, alkaline earth metal oxides, ZηO and basic A1203 are particularly preferred as basic additive; thus, the at least one basic additive is more preferably selected from the group consisting of MgO, ZηO, CaO and Al203, and even more preferably from the group consisting of MgO, CaO and ZηO. MgO is the most preferred basic additive.

Examples of organic acid additives include acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

Examples of other hydrophilic polymer or biodegradation promoter may include glycols, polyethers, and polyalcohols or other biodegradable polymers such as poly(glycolic acid), poly(lactic acid), polydioxanes, polyoxalates, poly(α-esters), polycarbonates, polyanhydrides, polyacetals, polycaprolactones, poly(orthoesters), polyamino acids, aliphatic polyesters such as poly(butylene)succinate, poly(ethylene)succinate, starch, regenerated cellulose, or aliphatic-aromatic polyesters such as PBAT.

Examples of suitable plasticizers that can promote disintegration consist of dimethyl sebacate, glycerin, triacetin, glycerol, monostearate, Sorbitol, erythritol, glucidol, mannitol. Sucrose, ethylene glycol, propylene glycol, diethylene glycol, triethylene glycol, diethylene glycol dibenzoate, dipropylene glycol dibenzoate, triethylene glycol caprate caprylate, butylene glycol, pentamethylene glycol, hexamethylene glycol, diisobutyl adipate, oleic amide, erucic amide, palmitic amide, dimethyl acetamide, dimethyl Sulfoxide, methyl pyrrolidone, tetramethylene Sulfone, oxamonoacids, oxa diacids, polyoxa diacids, diglycolic acids, triethyl citrate, acetyl triethyl citrate, tri-n-butyl citrate, acetyl tri-n-butyl citrate, acetyl tri-n-hexyl citrate, alkyl lactates, phthalate polyesters, adipate polyesters, glutate polyesters, diisononyl phthalate, diisodecyl phthalate, dihexyl phthalate, alkyl alylether diester adipate, dibutoxy ethoxyethyl adipate, and mixtures thereof.

In an embodiment or in any of the mentioned embodiments, the CE fibers and cellulose fibers in combination make up at least 50 wt. %, or at least 60 wt. %, or at least 70 wt. %, or at least 75 wt. %, or at least 80 wt. %, or at least 90 wt. %, or at least 95 wt. %, or at least 98 wt. %, or at least 99 wt. %, or at least 99.5 wt. %, or 100 wt. % of all the fibers present in the fabric or molded article.

In addition to the CE fibers, other synthetic fibers may be included in the fabrics and molded articles. Other types of synthetic fibers suitable for use in a blend with CE fibers can include, but are not limited to, nylon, rayon, viscose, mercerized fibers or other types of regenerated cellulose (conversion of natural cellulose to a soluble cellulosic derivative and subsequent regeneration) such as lyocell (also known as Tencel), Cupro, Modal, acetates such as polyvinylacetate, glass, polyamides including nylon, polyesters such as those polyethylene terephthalate (PET), polycyclohexylenedimethylene terephthalate (PCT) and other copolymers, olefinic polymers such as polypropylene and polyethylene, polycarbonates, poly sulfates, poly sulfones, polyethers, polyacrylates, acrylonitrile copolymers, polyvinylchloride (PVC), polylactic acid, polyglycolic acid, sulfopolyester fibers, and combinations thereof, and spandex (also known as lycra or estane).

In on embodiment, the fabrics and molded articles contain at least 7 wt. %, or at least 9 wt. %, or at least 10 wt. %, or at least 11 wt. %, or at least 13 wt. %, or at least 15 wt. %, or at least 18 wt. %, or at least 20 wt. %, or at least 23 wt. %, or at least 25 wt. % spandex, and in addition or in the alternative, up to 35 wt. %, or up to 33 wt. %, or up to 30 wt. %, or up to 28 wt. %, or up to 25 wt. %, or up to 23 wt. %, or up to 20 wt. %, or up to 18 wt. %, or up to 15 wt. %, or up to 13 wt. %, or up to 11 wt. %, or up to 10 wt. %, or up to 8 wt. % spandex, based on the weight of any one or more of:
a. CE fibers and spandex, or
b. All thermoplastic fibers, or
c. the fabric, or
d. the molded article.

The fabric or molded article may contain natural fibers. The amount of natural fibers may be present in an amount of not more than 50 wt. %, or not more than 40 wt. %, or not more than 35 wt. %, or not more than 30 wt. %, or not more than 25 wt. % or not more than 20 wt. % or not more than 15 wt. % or not more than 10 wt. % or not more than 8 wt. % or not more than 5 wt. % or not more than 3 wt. %, based on the weight of the fabric or molded article. Natural fibers are not generally thermoformable without addition of large amounts of plasticizer, and even then do not generally have good shape retention, therefore their amount in the fabric or molded article is kept minimal.

The fabrics containing the CE fibers are desirably molded by the application of heat and optionally pressure to provide a three-dimensional shaped article. The fabric is desirably thermoformed for a time sufficient to generate a three-dimensional article that retains its shape after release from the mold. The CE fibers are sensitive to the temperature. The set point of the mold temperature should be above the Tg glass transition temperature of the CE fiber, or at least 170° C. At temperatures below 170° C., the fabric containing CE fibers will not mold and hold its shape upon release. The mod temperature set point, or in addition or in the alternative the maximum fabric temperature in the mold, should not exceed 195° C. as we have found that molding fabrics above this temperature results in limp articles that have poor shape retention. The mold temperature set point, or in addition or in the alternative the maximum fabric temperature in the mold, is from 170° C. to 195° C., or less than 195° C., or from 175° C. to less than 195° C., or from 175° C. to 194° C., or from 177° C. to 194° C., or from 180° C. to 194° C., or from 185° C. to 194° C., or from 188° C. to 194° C., or from 190° C. to 194° C., or from 175° C. to 193° C., or from 177° C. to 193° C., or from 180° C. to 193° C., or from 185° C. to 193° C., or from 188° C. to 193° C., or from 190° C. to 193° C., or from 175° C. to 192° C., or from 177° C. to 192° C., or from 180° C. to 192° C., or from 185° C. to 192° C., or from 188° C. to 192° C., or from 190° C. to 192° C. To decrease the residence time in the mold, the set point of the mold temperature can be at or exceed 180° C., or be at least 185° C., such as from 180° C. to 194° C., or from 185° C. to 194° C., or from 188° C. to 194° C., or from 190° C. to 194° C., or from 180° C. to 193° C., or from 185° C. to 193° C., or from 188° C. to 193° C., or from 190° C. to 193° C., or from 180° C. to 192° C., or from 185° C. to 192° C., or from 188° C. to 192° C., or from 190° C. to 192° C. Molding temperature from 188° C. to 193° C. can produce good results in terms of short molding cycles, good shape retention, and good elastic recovery after hot wash cycles.

The particular molding temperature and residence time in mold is also sensitive to the kinds of fibers employed. For example, nylon 6,6, has a higher softening point and melting point than the CE fibers, and spandex fibers are also sensitive to heat and can lost their elasticity if too much heat energy is applied. While spandex/nylon blends can be successfully molded at temperatures above 195° C., the same moldings are limp and exhibit poor shape retention at these temperatures as the CE fibers become too soft as stretchy at these temperatures. However, the molded articles containing CE fibers can be successfully molded within the above temperature ranges even when combined with spandex or spandex and nylon 6,6.

The residence time in the mold is desirably short, desirably under 90 second, or under 60 seconds. Suitable residence time in mold is from 20 seconds to 60 seconds, or 30 seconds to 50 seconds, or 30 seconds to 45 seconds.

The fabric may be molded with other fabrics or with other materials, such as foams. The fabric, together with other materials in the mold, may be molded under a clamping pressure. The heat source may be thermal, microwave, infrared, conduction, ultra-sonics, and combinations thereof.

The basis weight of the fabrics used to make the moldings is at least 90 gsm, or at least 100 gsm, or at least 120 gsm, or at least 135 gsm, or at least 145 gsm, or at least 150 gsm, or at least 175 gsm, or at least 200 gsm, or at least 225 gsm, or at least 250 gsm, and in addition or in the alternative up to 400 gsm, or up to 350 gsm, or up to 325 gsm, or up to 300 gsm, or up to 275 gsm, or up to 250 gsm, or up to 225 gsm, or up to 200 gsm.

The articles made are desirably three-dimensional articles. One of the articles that can be made are supporting garments at least a portion of which are molded. Examples of supporting garments include a brassiere, sports bra or bralette (that is, a brassiere without underwire), swimwear, active wear, shoulder or knee paddings, or shapers. Other molded articles include shapeable and formable furniture cushions, automotive cushions and padded portions of the automotive interior, personal protection suits, hats, garters, sweat bands, belts, activewear, outerwear, rainwear, cold-weather jackets, medical compression garments, and bandages or splints.

### Example 1

Fabrics containing the CE fibers and other fibers identified in Table 1 below were molded in a bra mold under the temperature conditions noted in the table. The molded bra articles are determined as a pass/fail based on whether they could form a molded bra that successfully held the shape of the mold. The CE fibers used were Naia fibers available from Eastman Chemical Company that had at total denier and filament count as indicated in the Naia column. The denier per filament of each fiber is obtained by dividing the total denier by the filament count (e.g. 75/40=1.87 dpf). The bra size, fabric weight, kit type, and amount of spandex and its denier employed is identified in Table 1.

TABLE 1

| Fabric Development | | | | | | | | | Molding Trials | | | |
|---|---|---|---|---|---|---|---|---|---|---|---|---|
| | | | Lycra | | | | Weight | | Time | Temp | | Mold |
| | Naia ™ | % | (Regular) | % | Knit | GG | (GSM) | Color | (S) | ° C. | Size | (Pass/Fail) |
| 001 | Naia ™ 75/40 | 89 | 30d | 11 | SJ | 32 | 252 | Black | 35 | 190-197 | 34/40 | Fail |
| | bright | | | | | | | | | | | |
| 002 | Naia ™ 75/40 | 86 | 30d | 14 | SJ | 32 | 278 | Nude | 35 | 193 | 34/40 | Pass |
| | bright | | | | | | | | | | | |
| 003 | Naia ™ 75/40 | 86 | 30d | 14 | Inter | 36 | 360 | Nude | 35 | 193 | 34/40 | Pass |
| | bright | | | | | | | | | | | |
| 004 | Naia ™ 75/40 | 88 | 20d | 12 | Inter | 36 | 348 | Black | 35 | 193 | 34/40 | Pass |
| | bright | | | | | | | | | | | |
| 006 | Naia ™ 150/80 | 84 | 70d | 16 | SJ | 28 | 319 | White | 35 | 193 | 34/40 | Pass |
| | bright | | | | | | | | | | | |
| 011 | Naia ™ 75/40 | 88 | 30d | 12 | SJ | 36 | 254 | Black | 35 | 190-197 | 34/40 | Fail |
| | Black | | | | | | | | | | | |

It is shown from the initial molding application study that the Naia™ spandex fabric can be molded into bra applications. However, Naia™/spandex fabric shows inferior bursting strength numbers to typical fabric specifications for bra applications. Hence it was decided to add other stronger thermoplastic fiber with Naia™ to improve the fabric bursting strength.

### Example 2

| | Warp Knit (Tricot): 32gg | Circular Knit: 28gg | Circular Knit: 36gg |
|---|---|---|---|
| Fabric | Naia ™ 55/55d dul +20d | Naia ™ 75/40d dull | Naia ™ 55/17d dull |
| construction | Nylon +30d Spandex | +40d Nylon+30d | +20d Nylon+30d |
| details | Face (priority) & | Spandex | Spandex |
| | Sandwiched (1) | Single-Jersey | Single-Jersey |
| Naia™ | 45-75% | 55-65% | 60-67% |
| Nylon | <45% | <40% | <40% |
| Spandex | 7-18% | 8-10% | 10-13% |
| Color(s) | Skin/Light | Melange | Melange |
| | Melange | Skin & Light | Skin & Light |
| | Dark | Dark | Dark |
| GSM | 170-210 | 175-210 | 175-210 |
| Burst | 30 p.s.i. minimum | 30 p.s.i. minimum | 30 p.s.i. minimum |
| Strength | *added Nylon | *added Nylon | *added Nylon |
| Crease | | Adding | Heat & cool |
| | | Nylon | rate |
| | | Liquor rate | (Increase) |
| | | (Increase) | Cold drop |
| | | 1:20 | |
| | | Extra lube | |
| | | (Increase) | |
| | | - add lube | |
| | | before | |
| | | fabric | |
| | | loading | |
| Color shade/Moire | | Minimize | |
| | | beam dye | |
| | | shrinkage | |
| | | Tension | |
| | | ratio during | |
| | | batching | |
| | | Adequate | |
| | | heat setting | |
| | | Inside | |
| | | out/Outside | |
| | | In (liquor | |
| | | flow) | |
| Colorfastness | Minimum 3; check color | Minimum 3; check | Minimum 3; check |
| | pre & post softening | color pre & post | color pre & post |
| | treatment | softening treatment | softening treatment |
| Molding | Add anti-oxidant. Check | Add anti-oxidant. | Add anti-oxidant. |
| | molding performance pre & | Check molding | Check molding |
| | post softening treatment | performance pre & | performance pre & |
| | | post softening | post softening |
| | | treatment | treatment |

1. A thermoformed molded article comprising spandex and cellulose ester (“CE”) fibers.

2. The article of claim 1, wherein said molded article further comprises nylon 6,6 fibers, polyethylene terephthalate fibers, polyolefin fibers, or a combination thereof.

3. The article of claim 1, wherein the molded article contains at least 7 wt. % spandex based on the weight of a fabric used to make the molded article.

4. The article of claim 3, wherein said article contains not more than 20 wt. % natural fibers, based on the weight of the molded article.

5. The article of claim 1, wherein the article is a bra.

6. The article of claim 1, wherein the CE fibers have a denier per filament of not more than 5.

7. The article of claim 1, wherein the total denier of the CE fibers is not more than 250.

8. The article of claim 1, wherein the fibers contain filaments and have a filament count per fiber, and the filament count per fiber is less than 300.

9. The article of claim 1, wherein the CE fibers are continuous fibers having an average length of at least 125 mm.

10. The article of claim 1, wherein the CE fibers comprise cellulose acetate fibers.

11. The article of claim 10, wherein the CE fibers have a degree of substitution of at least 1.8 and not more than 2.5.

12. The article of claim 11, wherein the CE fibers are mono-component fibers.

13. The article of claim 1, wherein the CE fibers are obtained by solvent spinning.

14. The article of claim 1, wherein the CE fibers have a denier per filament of not more than 3, the total denier of the CE fibers is not more than 200, the CE fibers are continuous fibers having an average length of at least 150 mm, the CE fibers are mono-component fibers, and the CE fibers are obtained by solvent spinning.

15. The article of claim 14, wherein the CE fibers have a denier per filament of not more than 1.9, the total denier of the CE fibers is not more than 185, contains at least 7 wt. % spandex based on the weight of a fabric used to make the molded article, and contains not more than 20 wt. % natural fibers, based on the weight of the molded article.

16. A process for making a molded article comprising molding a fabric in a mold at a mold set point, or at a maximum fabric temperature, not exceeding 195° C., and for a residence time sufficient to obtain a molded article that retains its shape upon release from the mold, said fabric comprising cellulose ester (“CE”) fibers.

17. The process of claim 16, wherein the article is a bra and the residence time of the fabric in the mold is under 60 seconds.

18. The process of claim 16, wherein the basis weight of the fabric is at least 90 gsm.

19. The process of claim 16, wherein the CE fibers have a denier per filament of not more than 3, the total denier of the CE fibers is not more than 200, and the CE fibers are mono-component fibers.

20. The process of claim 16, wherein the CE fibers have a denier per filament of not more than 1.9, the total denier of the CE fibers is not more than 185, the article contains at least 7 wt. % spandex based on the weight of a fabric used to make the molded article, and contains not more than 20 wt. % natural fibers, based on the weight of the molded article.
